(19) United States
(12) Patent Application Publication
(10) Pub. No.: US 2002/0005035 A1
(43) Pub. Date: Jan. 17, 2002

(54) Guard unit for agricultural cutting machine

(76) Inventor: Oscar Pedro Hovsepian, Buenos Aires (AR)

Correspondence Address: Gregory P. LaPointe, BACHMAN & LaPOINTE, P.C., Suite 1201, 900 Chapel Street, New Haven, CT, 06510-2802, US

(21) Appl. No.: 09/893,842

(22) Filed: Jun. 28, 2001

(30) Foreign Application Priority Data
Jun. 29, 2000 (AR) P 000103293

(51) Int. Cl. A01D 34/18

(52) U.S. Cl. 56/298; 56/307

(57) ABSTRACT

A guard unit for agricultural cutting machine, such as those used by grass, cereals and vegetables cutting machines in general, having a cutting device composed by two transversal sweeps with their cogs facing forwards and arranged over the ground with a minimum separation. A fixed sweep is composed by the transversal alignment of a plurality of guards units mounted on a longitudinal-shaped holder; while the other sweep is mobile, also transversal, and it is composed by a plurality of triangular knives mounted on a longitudinal-shaped knife holder bar making swinging movements so that the cuts could be carried out by shearing.

The invention relates to a GUARD UNIT FOR AGRICULTURAL CUTTING MACHINE, such as those used by grass, cereals and vegetables cutting machines in general, having a cutting device composed by two transversal sweeps with their cogs facing forwards and arranged over the ground with a minimum separation. A fixed sweep is composed by the transversal alignment of a plurality of guards units mounted on a longitudinal-shaped holder; while the other sweep is mobile, also transversal, and it is composed by a plurality of triangular knives mounted on a longitudinal-shaped knive holder bar making swinging movements so that the cuts could be carried out by shearing.

### GENERAL DESCRIPTION

More specifically, this invention entails an guard unit capable of being used in the conformation of the above mentioned fixed sweep since it has a series of novel constructive and very advantageous features, being the integral operation of the cutting machine optimized due to the increased efficiency and simplified maintenance task.

These guards forming the fixed sweep of the cutting device are those arranged in the lowest level of the cutting plane so that, during the advance of the machine they usually get in contact with the floor adapting themselves to the uneven ground formations.

These guards are formed into guard units which are mounted on pluralities over an unique longitudinal-shaped support bar expanding while embracing the front part of the machine. They are arranged one after the other and are fixed by adjustable bolts with nut.

The mobile sweep bearing the knives, is associated to means imparting transversal swinging movements, having the same lenght than that of the fixed sweep and holding a plurality of knives composed by substantially flat plates of steel that, in relation to each guard, defines a triangular coplanar extension which sides are sharp and act as cutters by shearing over the flanks of such fixed guards.

For the purpose of this invention, the above mentioned guards are usually made up of steel with lateral borders in angle and sharp edges.

There are known embodiments where such triangular knives from the mobile sweep with sharp bevelled borders include jagged edges, such slopes having bevelled borders are alternated, i.e., when a knive bevelled border is facing downwards, the following bevelled border is upwards. Such embodiment allows a longer duration of sharp edges.

The greater or lesser efficiency of a cutting machine of this kind lies in the height of the cutting since the best result depends on it. The lower is the height of the cutting, the better are the obtained yields.

Versatility and adaptability to irregularities of ground surface also influence, since the shear cut and the durability of sharp elements are increased.

### PRIOR ART

The guard units for cutting machines are known, being composed according to structural rigid pieces containing pairs of guards in only one unit, although being equal to each other, they stay apart and are parallel. They are made up of tempered steel and each unit is jointly arranged to the same structural flat bar being part of the machine frame.

There are known cases where these fixed guards units are pieces containing more than two guards. However, it is usual that each guard unit comprises a couple of rigid guards linked to each other by means of transversal sections extending between them, defined in the back area of such unit, so that they maintain an uniform and definitive separation and free spaces between them which are foreseen for the inclusion of anchorage means to the transversal longitudinal-shaped bar support, as well as for the location and operation of the mobile sweep.

In these guard units, each guard is comprised of two metallic portions, a top one and a lower one, that being equal to each other, maintain a mutual separation in its back and intermediate sections, which is specially foreseen for the location of the aforementioned cutting knives, generally triangular and with sharp side borders, which, on the other hand, are jointly associated to driving means, in a well-known longitudinal-shaped rod that, causes the above mentioned swinging movements producing the cut during the advance of the machine. So that, the aforementioned top and lower portions, are attached themselves in the front sector forming a solid attack tip of convergent flanks towards the free front end.

That is to say, from such front sector these metallic top and lower portions arise, which side border flanks have features specific for the cut they carry out together with the knives that are arranged among them. They are bevelled borders, provided with cogs having divergent slopes down.

The purpose of the separation between such metallic top and lower portions in the back and intermediate sector, is to leave a space allowing the passage of the mobile rod, which carries the triangular cutting knives in their swinging movements.

Also, the separation between such metallic top and lower portions in the back sector is greater than in the previous sections because a space for the anchorage of each unit to the transversal longitudinal-shaped bar support is left, as well as of the knives carrier mobile transversal rod.

In such back sector the transversal sections that each unit has in order to establish the joint of the couple of adjacent rigid, equal and parallel guards, are defined maintaining a wide opening that, besides reducing weight allows to check if the maintenance tasks and repair of knives holder rods are carried out.

As it is well-known, although these cutting devices are efficient, since they are required in very diverse agricultural activities, they are usually subjected to long and demanding tasks so that some drawbacks promoting maintenance tasks and constant repair still remain.

Such drawbacks are related to the fact that they are devices that contact the ground and shock against plants they cut during the advance of the machine and, at the same time they carry out the cutting action, so that their constituent elements are subjected to several additional efforts resulting in the stress of the fixing points, such as the welding points with which the knives are installed.

Such drawbacks are also shown in undesirable obstructions taken place by plants rests that become jammed in the cutting device producing obstacles for the normal discharge of the cuttings that are being produced. This is because the guard units have shock sections hindering the normal passage of the cut plants that are discharged backwards.

### NOVELTY OF THE INVENTION—MAIN OBJECT

The guard unit referred to in this invention is more efficient than all the guard units known at present because it has a series of constructive modifications specially designed to solve the above mentioned general problems.

Firstly, it stands out because in its back sector the metallic sections separated from each guard, define marked arches that determine between them a space higher than those of the current guard units. This allows that the cutting knives, are linked to the knives holder rod by adjusting bolts, instead of fixing through welding as it is currently perfomed. Thus, if for some reason a knive becomes unfastened, the operator himself can replace it “in situ” without transferring the machine to the repairs shop to weld a new knive.

The same enlarged space in the back sector is used for the installation of a back support surface for the knives holder mobile rod that, without affecting the transversal swinging displacements that it should carry out, assures that the knives do not carry out undesirable shaking movements that affect the cutting and diminish its durability. That is to say, the aim is that all knives stay acting in a horizontal uniform level.

The appropriate constructive improvements, are combined with the modification in the distal end or shock end of each guard where the sharp tips are up-oriented to form support skates to the ground and prevent the usual tendency to be nailed in the ground thus affecting the normal advance of the machine. The aim is to confer them a “curled up” upwards to avoid the tendency to be nailed in the ground when the additional irregular movements occurring in all the advances with these tasks take place.

Indeed, in numerous applications such as in the soya harvesting, it is convenient that the guards advance to the ground level because the cuts should be very low to assure a good crop and avoid unwanted losses. The above mentioned “respingues” cause the unstable support to be glidant and adapted to ground irregularities.

The above mentioned constructive modifications, are combined with other modifications that also favor work efficiency and maintenance tasks decrease. Among them, the holes and bolts design for the guard unit fixation in the carrier fixed bar, specially designed to impede and assure that the cut plants do not get jammed in the front part of the cutting machine thus obstructing their normal passage backwards as the machine advances, stand out.

The same purpose is stated in the couple of frontal union bolsters among adjacent guards in the same guard unit. These bolsters that are defined in the back sector of the unit have an oblique orientation, convergent towards the attack front side of the machine. Thus, another factor of undesirable obstructions that the cut material may produce is diminished. That is to say, it is assured that the flow of cut cereal will always be continuous and without undesirable obstructions and frontal shocks, as the machine advances slipping its cut front the best way.

From the description above, it clearly arises that it is the main object of the present invention—GUARD UNIT FOR AGRICULTURAL CUTTING MACHINE of the type that comprises two equal and parallel adjacent guards defined by means of two superimposed tempered steel plates, which maintain a mutual separation in their back and intermediate sectors, as long as they are joined in their front sectors to conform the sharp tips of distal end. Such sharp tips of distal end are curved up defining respective slip skates, after which the intermediate sector begins where there is an uniform separation being greater than the thickness of the cutting knives, after which the back sector begins where both steel plates define the respective wide central openings (through which it crosses the knives holder rod) delimited by lateral arched sections and superior protrusive sections, lower flat sections and a couple of oblique front bolsters, which are convergent towards the same advance direction of the machine while such back sector finishes in the transversal flat sections and horizontal sections where the passing holes are included for the passage from fixing bolts to the carrier bar arranged between them, among which a sickle bar is also disposed providing sliding support for the back section of the horizontal cutting knives.

The novelty that the cutting knives are fixed to the knives holder rod by means of pairs of vertical adjusting bolts is outstanding.

Furthermore, the novelty that at least two of the passing holes, which are defined in the back sector of the superimposed steel plates are squares, is also outstanding.

### BRIEF DESCRIPTION OF THE FIGURES

In order to show the above mentioned advantages, to which the users and experts will be able to add many others and in order to ease the understanding of the constructive, constituent and functional features of the manufactured guard unit, it is described hereinbelow a preferred example of an embodiment, which is schematically illustrated and without a particular scale, in the enclosed sheets with the express explanation that, by way of example, it does not correspond to assign it a limitating or exclusive character of the scope of this invention, but simply a merely explanatory and illustrative intention of the basic conception in which it is based on.

FIG. 1 is a perspective view which shows a guard unit for mounting on the fixed sweep of a cutting machine which meets the conditions and modifications that are stated in this patent application.

FIG. 2 is a cross-sectional view according to the trace plane II-II indicated in the previous figure.

FIG. 3 is a longitudinal view according to the trace plane III-III indicated in FIG. 4.

FIG. 4 is an upper view of the same guard unit of the previous figures.

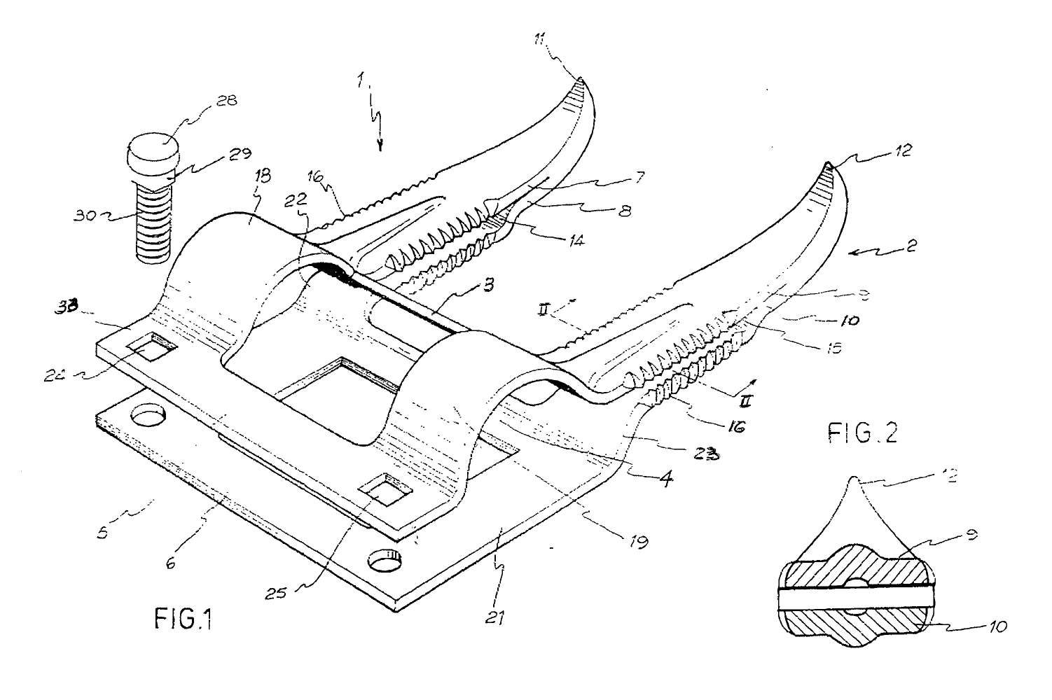

It is stated that in all figures the same reference numbers correspond to the same or equivalent parts or constituent elements of the group, according to the selected example for the present explanation of the manufacured guard unit.

### DESCRIPTION OF A PREFERRED EMBODIMENT

As it can be appreciated from FIG. 1, the guard unit for agricultural cutting machine, which is referred to in this patent application, is an unique and monolithic carrier structure of two guards -1- and -2- equal to each other and parallely disposed, which are arranged at a predetermined distance that is stated by the couples of front bolsters -3- and -4- and rear bolsters -5- and -6- defined in the back sector of the unit.

They are very resistant and rigid units preferably of type “SAE 1010” steel, subjected to a thermal treatment of deep Carbonitriding 0.6 plus 0.2 mm. diffusion) at the same time that they are hardened and tempered at 56-58 Rc.

Preferably, this unit includes a superficial treatment of “Bichromatizing” and “Gilding”.

It is also contemplated that the constituent material may be made up of cemented iron. As it was previously stated, each guard comprises two superimposed portions -7- and -8-, -9- and -10- that, in its front or frontal sector -11- and -12-, are joined to define sharp and curved up ends adopting a formation such as the one of the respective skates of longitudinal displacement guided in equal sense and direction of advance of the machine. In the intermediate sectors, the respective lower portions -8- and -10- define the corresponding steps -14- and -15- by means of which a specially foreseen space of mutual separation is determined to allow the swinging displacement of the cutting knives which sharp side borders act on the jagged side borders -16 and -17- to produce the cuts by shearing.

The suitable mutual separation increases in each guard when the back sector of the unit is defined. In this sector, the superior portions -18- and -19- determine respective protrusive arches, as long as the inferior portions -20- and -21- are flat, but they are defined starting from the descending steps -22- and -23- producing an increase in this separation space. Between both pairs of lateral portions the corresponding central openings are defined by the mentioned front bolsters -3- and -4- and rear bolsters -5- and -6-.

The novelty that distinguishes this embodiment in relation to the guard units known in the market, lies in that the front ends -11- and -12- are curved up, combined with the highest space volume which is defined in the back sector and the orientation of convergent slope towards the front of shock of bolsters -3- and -4-.

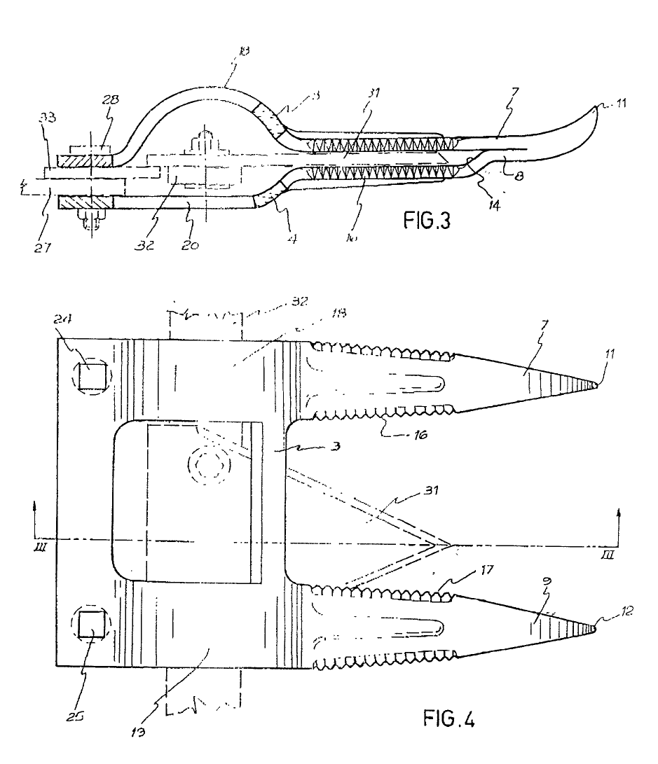

Besides, it is also outstanding that the condition that the holes -24- and -25- have a square opening to assure that the anchorage bolts -26-, which are used for fixing each guard unit to the carrier bar -27- (shown in FIG. 3), cannot rotate after being adjusted. This is the reason why these bolts have a special design due to they possess a rounded or helmet-shape head -28- and a superior neck of faceted sides -29- which tightly clamp in such holes -24- and -25- after which the threaded body -30- is prolonged.

Referring now to FIGS. 3 and 4, it is possible to appreciate the functional advantages that arise from the above mentioned constructive modifications. Indeed, with reference -31- a triangular cutting knive which active section is disposed in the space determined by the jagged flanks -16- in both guards is represented.

The novelty resides in that each knive is fixed to the control rod -32- by means of the bolting resource, which allows its replacement in a simple and direct way since the internal space is big enough as to allow the access of any conventional tool.

Furthermore, such mentioned extended space where the knives holder rod -32- acts allows the inclusion of the back support flat bar -33- which is disposed on the same bar -27- of the guard units. As it was indicated above, this flat bar -33- acts as a superficial support to knives -31- which assures the maintenance of their correct position during cutting movements.

Once the nature and subject-matter of this patent application were described and illustrated, as well as the way in which they can be put into practice, it is declared to claim as property and exclusive rights the following:

1. GUARD UNIT FOR AGRICULTURAL CUTTING MACHINE of the type that comprises two equal and parallel adjacent guards defined by means of two superimposed tempered steel plates which maintain a mutual separation in their back and intermediate sectors, as long as they are joined in their front sectors to conform the sharp tips of distal end characterized by these sharp tips of distal end, which are curved up defining respective slip skates, after which the intermediate sector begins where there is an uniform separation being greater than the thickness of the cutting knives, after which the back sector begins where both steel plates define the respective wide central openings (through which it crosses the knives holder rod) delimited by lateral arched sections and superior protrusive sections, lower flat sections and a couple of oblique front bolsters, which are convergent towards the same advance direction of the machine while such back sector finishes in the transversal flat sections and horizontal sections where the passing holes are included for the passage from fixing bolts to the carrier bar arranged between them, among which a sickle bar is also disposed providing sliding support for the back section of the horizontal cutting knives.

2. According to claim 1, the GUARD UNIT is characterized by the cutting knives that are fixed to the knives holder rod by means of pairs of vertical adjusting bolts.

3. According to claim 1, the GUARD UNIT is characterized by at least two of the defined passing holes in the back sector of the superimposed steel plates that are squares.
